(19) United States
(12) Patent Application Publication
(10) Pub. No.: US 2010/0170355 A1
(43) Pub. Date: Jul. 8, 2010

(54) ROTARY ACTUATOR AND MANUFACTURING METHOD OF THE SAME

(75) Inventors: Mikine KUME, Chiryu-city (JP); Shigeru Yoshiyama, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/652,230

(22) Filed: Jan. 5, 2010

(30) Foreign Application Priority Data
Jan. 8, 2009 (JP) 2009-2716

(51) Int. Cl. F16H 1/00; B23P 11/00

(52) U.S. Cl. 74/63; 29/428

(57) ABSTRACT

An electric motor drives and rotates a rotor shaft, and a speed reducer reduces speed of rotation of the rotor shaft and outputs the rotation. A shaft is fixed to a front housing. A turning member is meshed with an external teeth member provided to an output shaft of the speed reducer and is supported to be able to rotate around an axis line of the shaft. A turning angle sensor senses a turning angle of the turning member by sensing a magnetic field corresponding to a turning angle of a magnet section provided to the turning member. An outer wall of a cup is fixed to the turning member, and an inner wall of the cup is fitted to a ball bearing. A plate is provided slidably between a bottom outer wall surface of the cup and an end surface of the front housing around the shaft.

### CROSS REFERENCE TO RELATED APPLICATION

This application is based on and incorporates herein by reference Japanese Patent Application No. 2009-2716 filed on Jan. 8, 2009.

### BACKGROUND OF THE INVENTION

1. Field of the Invention

The present invention relates to a rotary actuator that drives a shift range switching device of an automobile and to a manufacturing method of the rotary actuator.

2. Description of Related Art

Conventionally, as a shift range switching device of an automobile, there has been publicly known a shift-by-wire system that senses a shift range, which is selected by a driver, with an electronic control unit (ECU) of a vehicle and that drives and controls a rotary actuator in accordance with the sensing value, thereby switching the shift range of an automatic transmission, for example, as described in Patent document 1 (JP-A-2005-265151).

The applicants of the present application have conceived a scheme of attaching a shift position sensor, which senses a set position of the shift range of the automatic transmission, radially outside an output shaft of the rotary actuator in order to inhibit deterioration of mountability of the rotary actuator in such the shift-by-wire system. There is a concern that inclination of a drive shaft of the shift range switching device connected to the output shaft affects the shift position sensor in this kind of the rotary actuator.

### SUMMARY OF THE INVENTION

It is an object of the present invention to provide a rotary actuator improving sensing accuracy of a shift position sensor.

According to an aspect of the present invention, an electric motor drives and rotates a rotor shaft. A speed reducer reduces speed of rotation of the rotor shaft and outputs the rotation. A housing accommodates the electric motor and the speed reducer. A shaft is fixed to the housing. A bearing has an inner race fixed to the shaft and an outer race provided to be able to rotate relative to the inner race. An external teeth member is provided radially outside an output shaft of the speed reducer and rotates together with the output shaft. A turning member has external teeth meshed with the external teeth member and is supported such that the turning member can turn about an axis line of the shaft. A magnet section is provided to the turning member. A turning angle sensing device senses a turning angle of the turning member by sensing a magnetic field corresponding to a turning angle of the magnet section. A cup is formed in the shape of a cylinder having a bottom. An outer wall of the cup is fixed to an inner wall of a shaft hole of the turning member and an inner wall of the cup is fitted to an outer wall of the outer race of the bearing. A restriction section is provided around the shaft of the housing and slidably contacts a bottom outer wall surface of the cylindrical shape of the cup having the bottom. Thus, axial movement of the bottom outer wall surface of the cup is restricted, and inclination of a turning central axis of the turning member with respect to the axis line of the shaft is inhibited. Thus, change of the magnetic field of the magnet section due to the inclination of the turning central axis of the turning member is inhibited, and the turning angle sensing device can correctly sense the change of the magnetic field of the magnet section caused by circumferential movement of the turning member. As a result, the turning angle of the output shaft is sensed correctly, and the sensing accuracy of the shift position sensor that senses the set position of the shift range of the automatic transmission can be improved.

According to another aspect of the present invention, the restriction section slidably contacts an axial outer wall surface of the turning member. Therefore, axial movement of the outer wall surface of the turning member is restricted, and the inclination of the turning central axis of the turning member with respect to the axis line of the shaft is inhibited. Thus, the turning angle sensing device can correctly sense the change of the magnetic field of the magnet section caused by the circumferential movement of the turning member.

According to another aspect of the present invention, the restriction section is a plate that has one side surface slidably contacting an end surface of the housing around the shaft and that has the other side surface slidably contacting at least one of the bottom outer wall surface of the cup and the axial outer wall surface of the turning member. Therefore, axial movement of the bottom outer wall surface of the cup can be restricted with a simple and secure construction. Furthermore, a frictional force between the end surface of the housing around the shaft and both of the bottom outer wall surface of the cup and the axial outer wall surface of the turning member can be reduced.

According to another aspect of the present invention, a manufacturing method for manufacturing the rotary actuator has first to fourth processes. The first process fixes the shaft to the housing. The second process fixes the cup to the inner wall of the shaft hole of the turning member. The third process fits the outer wall of the outer race of the bearing to the radial inner wall of the cup, The fourth process fits an inner wall of the inner race of the bearing to the shaft fixed to the housing and places the bottom outer wall surface of the cylindrical shape of the cup having the bottom and the restriction section in contact with each other slidably. Therefore, when the bearing is press-fitted to the shaft, the positioning of the shaft and the turning member can be performed and the bottom outer wall surface of the cup and the restriction section can be placed in contact with each other slidably. Thus, axial movement of the bottom outer wall surface of the cup can be restricted, and the inclination of the turning central axis of the turning member with respect to the axis line of the shaft can be inhibited.

According to yet another aspect of the present invention, the fourth process further places an axial outer wall surface of the turning member and the restriction section in contact with each other slidably when the bearing is press-fitted to the shaft. Thus, axial movement of the outer wall surface of the turning member can be restricted, and the inclination of the turning central axis of the turning member with respect to the axis line of the shaft can be inhibited.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1 is a cross-sectional view showing a rotary actuator according to an embodiment of the present invention;

FIG. 2 is a schematic diagram showing a shift-by-wire system applied with the rotary actuator according to the embodiment;

FIG. 3 is a cross-sectional view showing a substantial part of the rotary actuator according to the embodiment;

FIG. 4 is a view showing a shift position sensor according to the embodiment along a direction of an arrow mark IV of FIG. 3 in a state where a cover of the shift position sensor is removed;

FIG. 5 is a cross-sectional view showing a substantial part of a rotary actuator of a comparative example of the present invention; and

FIG. 6 is a view showing a shift position sensor of the comparative example along a direction of an arrow mark VI of FIG. 5 in a state where a cover of the shift position sensor is removed.

### DETAILED DESCRIPTION OF EXAMPLE EMBODIMENT

### (Embodiment)

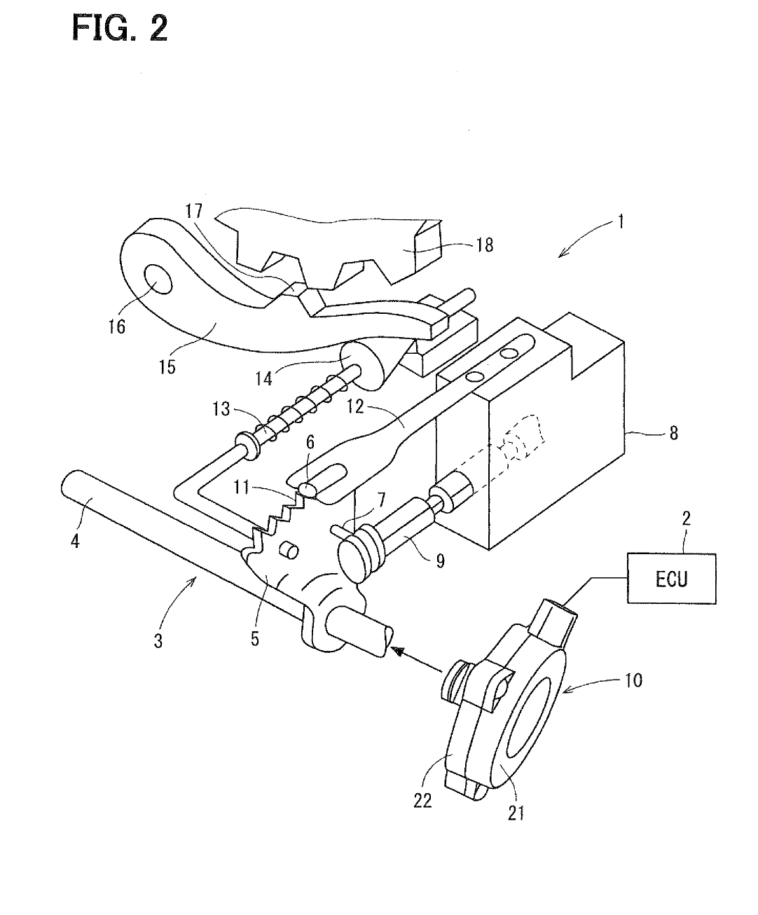

A rotary actuator according to an embodiment of the present invention will be explained based on the drawings. The rotary actuator according to the present embodiment is applied as a drive section of a shift range switching device 1 that switches a shift range of an automatic transmission of an automobile as shown in FIG. 2. The rotary actuator performs switching drive of the shift range and a parking gear. The shift range switching device 1 has an electronic control unit 2 (ECU) that outputs a drive signal to the rotary actuator 10. The rotary actuator 10 rotates according to the drive signal inputted from the ECU 2 and outputs the rotation to a driving force transmission section 3.

The driving force transmission section 3 consists of a drive shaft 4, a detent plate 5, a stopper 6 and the like. One end portion of the drive shaft 4 is coupled to an output shaft of the rotary actuator 10 by a spline. The detent plate 5 is formed in the shape of a fan extending radially outward from the drive shaft 4 and rotates integrally with the drive shaft 4. A pin 7 protruding parallel to the drive shaft 4 is provided to the detent plate 5. The pin 7 is engaged with an end portion of a manual spool valve 9 provided to a hydraulic valve body 8. Therefore, the manual spool valve 9 reciprocates in an axial direction due to the detent plate 5 rotating integrally with the drive shaft 4. The manual spool valve 9 reciprocates in the axial direction to switch a hydraulic supply passage extending to a hydraulic clutch of an automatic transmission (not shown). As a result, an engagement state of the hydraulic clutch switches, and the shift range of the automatic transmission is changed.

The detent plate 5 has multiple recesses 11 on its radial end portion. The recesses 11 respectively correspond to a P range, an R range, an N range and a D range as the shift ranges of the automatic transmission. When the stopper 6 supported at a tip of a plate spring 12 engages with a certain recess 11 of the detent plate 5, an axial position of the manual spool valve 9 is decided. If torque is applied from the rotary actuator 10 to the detent plate 5 via the drive shaft 4, the stopper 6 moves from the certain recess 11 to another adjacent recess 11. Thus, the axial position of the manual spool valve 9 changes.

A parking rod 13 substantially in an L-shape is connected to the detent plate 5. A cone section 14 is provided to an end portion of the parking rod 13 opposite from the detent plate 5. The parking rod 13 converts the rotational motion of the detent plate 5 into linear motion, whereby the cone section 14 reciprocates in the axial direction. A parking pole 15 is in contact with a side surface of the cone section 14. The parking pole 15 is driven to rotate around a shaft 16 by the reciprocation of the parking rod 13. If a protrusion 17 provided on the parking pole 15 along a direction of the rotation of the parking pole 15 engages with a gear of a parking gear 18, rotation of the parking gear 18 is restricted. Thus, driving wheels are locked via a drive shaft, a differential gear or the like (not shown). If the protrusion 17 of the parking pole 15 disengages from the gear of the parking gear 18, the parking gear 18 becomes rotatable and the lock of the driving wheels is cancelled.

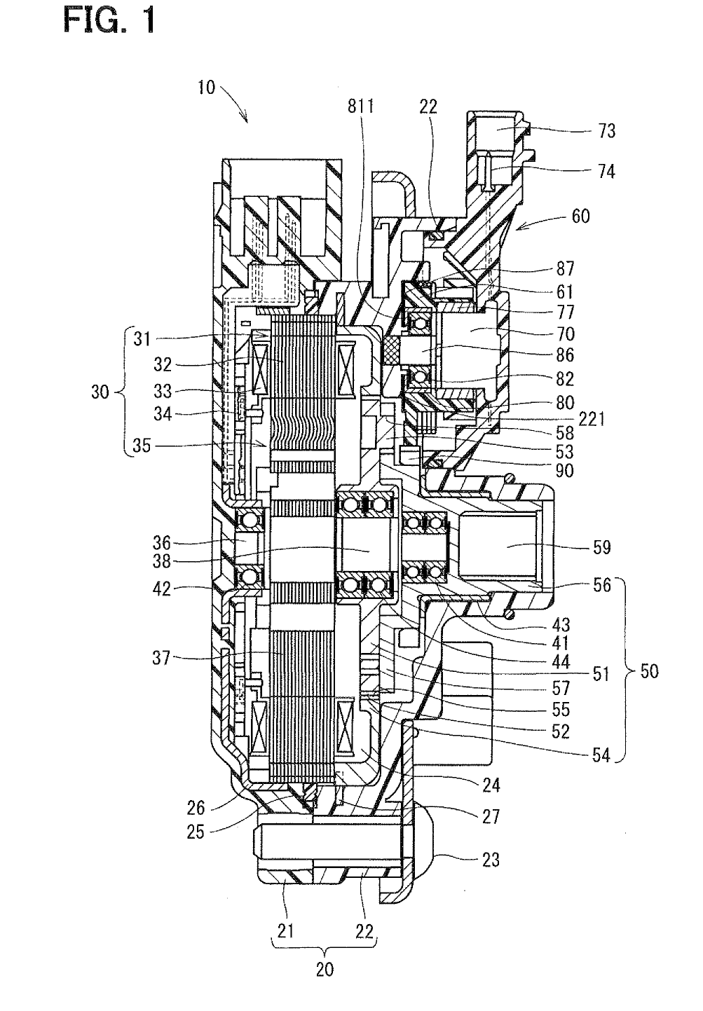

Next, the rotary actuator 10 will be explained. As shown in FIG. 1, the rotary actuator 10 has a housing 20, an electric motor 30, a speed reducer 50, a shift position sensor 60 and the like. The housing 20 consists of a rear housing 21 and a front housing 22. The rear housing 21 and the front housing 22 are formed of a resin. The front housing 22 and the rear housing 21 are fixed by a bolt 23. An internal space 24 is formed between the front housing 22 and the rear housing 21. The electric motor 30, the speed reducer 50 and the like are accommodated in the internal space 24. An elastic member 25 that is formed in the shape of a circular ring and that has an elasticity is held in a position where the front housing 22 and the rear housing 21 contact each other.

The electric motor 30 is an SR motor (switched reluctance motor) as a brushless motor that generates a driving force without using a permanent magnet. The electric motor 30 has a stator 31 and a rotor 35. The stator 31 is formed substantially in the shape of a circular ring and is press-fitted into a metallic fixation plate 26, which is inserted in the rear housing 21 by insert molding. Thus, the stator 31 is fixed to the rear housing 21 such that the stator 31 cannot rotate. The stator 31 consists of a stator core 32 and coils 33. The stator core 32 is formed by stacking multiple layers of thin plates in a thickness direction. The stator core 32 has multiple stator teeth protruding radially inward at every 30 degrees. The coils 33 are wound around the stator teeth respectively. The coils 33 are electrically connected to a busbar section 34 provided on the rear housing 21 side of the stator 31. The busbar section 34 supplies electric power to the coils 33.

The rotor 35 is provided on an inner peripheral side of the stator 31. The rotor 35 consists of a rotor shaft 36 and a rotor core 37. One end portion of the rotor shaft 36 is rotatably supported by a front bearing 41, and the other end portion of the rotor shaft 36 is rotatably supported by a rear bearing 42. The front bearing 41 is fitted and fixed to an inner periphery of an output shaft 56 of the speed reducer 50 explained later. The output shaft 56 is rotatably supported by a metallic bearing 43 provided on an inner periphery of the front housing 22. Therefore, one end portion of the rotor shaft 36 is supported by the front bearing 41, the output shaft 56 and the metallic bearing 43 such that the one end portion can rotate with respect to the housing 20.

The rotor core 37 is formed by stacking multiple layers of thin plates in a thickness direction and is press-fitted to the rotor shaft 36. The rotor core 37 has multiple rotor teeth protruding at every 45 degrees toward the stator core 32 radially outside the rotor core 37. If an energization position and an energization direction of the coils 33 are switched sequentially based on the drive signal outputted from the ECU 2, the stator teeth magnetically attracting the rotor teeth switch sequentially, and the rotor 35 rotates in one direction or in the other direction. Thus, the rotor 35 can be rotated in an arbitrary direction by switching the energization of the coils 33 and by controlling the magnetic force generated in the coils 33.

The speed reducer 50 has a sun gear 51, a ring gear 54, the output shaft 56 and the like. The speed reducer 50 is a kind of an epicyclic gear device. The rotor shaft 36 mentioned above has an eccentric section 38 on the output shaft side of the rotor core 37 with respect to the axial direction. The eccentric section 38 performs eccentric rotation with respect to the rotational center of the rotor shaft 36. The sun gear 51 is formed substantially in the shape of a disk and has external teeth 52 on its outer periphery. The sun gear 51 is supported by the eccentric section 38 through a middle bearing 44 such that the sun gear 51 can perform relative rotation with respect to the eccentric section 38. Therefore, the sun gear 51 performs eccentric rotation with respect to the rotor shaft 36.

The ring gear 54 is formed substantially in the shape of a circular ring and is press-fitted to a metallic fixation plate 27, which is inserted in the front housing 22 by insert molding. Thus, the ring gear 54 is supported such that the ring gear 54 cannot perform relative rotation with respect to the front housing 22. The ring gear 54 has internal teeth 55 on its inner periphery. The above-mentioned sun gear 51 is structured such that the sun gear 51 rotates due to the rotation of the eccentric section 38 while one of the external teeth 52 meshes with the internal teeth 55 of the ring gear 54. Thus, when the sun gear 51 rotates eccentrically with respect to the rotor shaft 36, the external teeth 52 are serially meshed with the internal teeth 55 of the ring gear 54, whereby the sun gear 51 rotates in a direction opposite to the rotation direction of the rotor shaft 36. Because of the numbers of the teeth of the sun gear 51 and the ring gear 54, the rotation speed of the sun gear 51 becomes rotation speed, which has been reduced to 1/60 of the rotation speed of the rotor shaft 36, for example.

The output shaft 56 has a radial flange 57 that slidably contacts an axial side surface of the sun gear 51. Multiple pin holes 58 are formed in the flange 57 on the same circle. Multiple pins 53 protruding to the flange 57 side are formed on the sun gear 51. The multiple pins 53 are loosely inserted into the pin holes 58 of the output shaft 56 respectively. If the sun gear 51 rotates, power is transmitted from the pin 53 to an inner wall of the pin hole 58 of the output shaft 56. Thus, a rotation component of the sun gear 51 is transmitted to the output shaft 56.

A joint hole 59 is formed in an axial end portion of the output shaft 56 opposite from the flange 57. The drive shaft 4 of the shift range switching device 1 is inserted into the joint hole 59. A spline groove is formed on an inner wall of the joint hole 59 of the output shaft 56 and can join with a spline groove formed on an outer wall of the drive shaft 4. Thus, the rotary actuator 10 rotates and drives the drive shaft 4 of the shift range switching device 1.

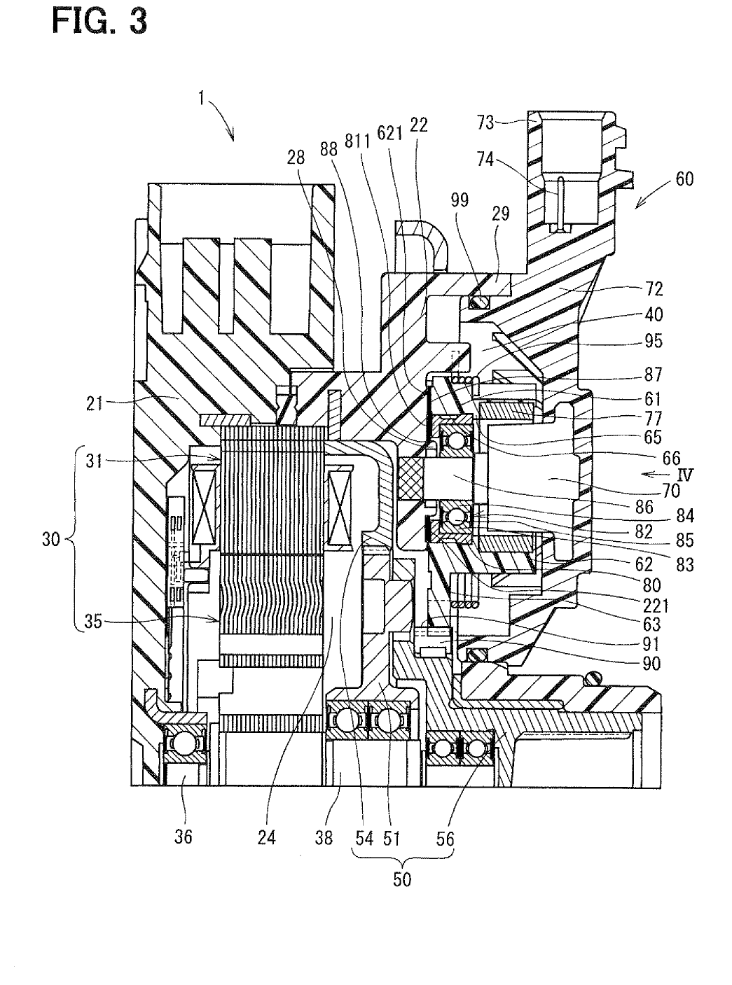

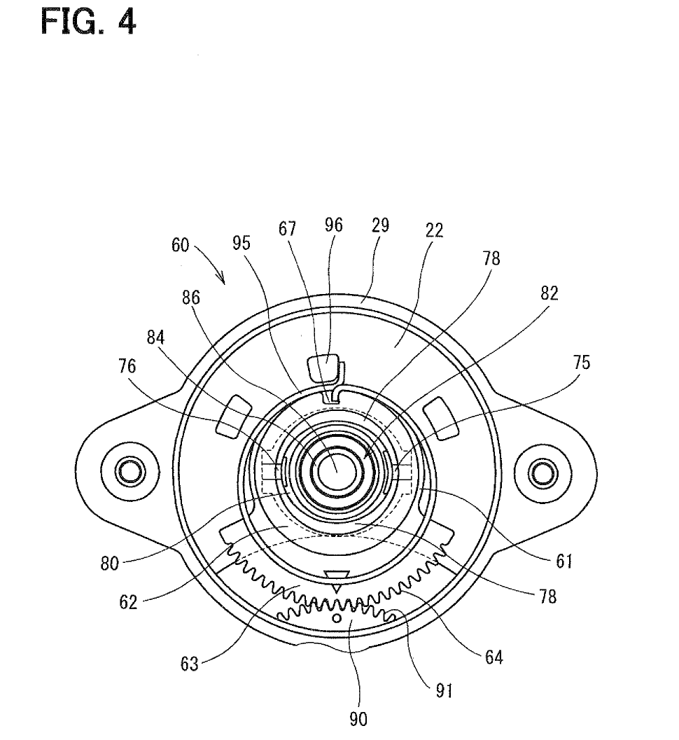

As shown in FIGS. 3 and 4, the shift position sensor 60 consists of a shaft 86, a turning member 61, an external teeth member 90, a cup 80, a ball bearing 82 as a bearing, a plate 87 as a restriction section, a turning angle sensor 70 as a turning angle sensing device and the like. FIG. 4 is a diagram showing the shift position sensor 60 of FIG. 3 along a direction of an arrow mark IV in a state where a cover 72 is removed. The rear housing 21 is not shown in FIG. 4. For example, the shaft 86 is formed of a metal in the shape of a circular column. The shaft 86 is provided radially outside the output shaft 56 such that an axial direction of the shaft 86 is substantially parallel to the axial direction of the output shaft 56. One end portion of the shaft 86 is inserted in the front housing 22 by insert molding. The other end portion of the shaft 86 protrudes to a side of the front housing 22 opposite from the internal space 24. A knurl is provided on a radial outer wall of the one end portion of the shaft 86. Therefore, the shaft 86 is fixed to the front housing 22 such that the shaft 86 cannot perform relative rotation with respect to the front housing 22.

For example, the turning member 61 is formed of a resin and is provided such that the turning member 61 can turn about the axis line of the shaft 86. The turning member 61 has a cylinder section 62 and a fan section 63 extending radially outward from the cylinder section 62 in the shape of a fan. The cylinder section 62 is formed in the shape of a cylinder and has a shaft hole 66 on its inner peripheral side. The fan section 63 has external teeth 64 on its radial outer end portion.

The external teeth member 90 is formed of a metal in the shape of a circular ring and is fitted to a radial outer wall of the output shaft 56 of the speed reducer 50. The external teeth member 90 rotates together with the output shaft 56. The external teeth member 90 has external teeth 91 on its radial outer end portion. The external teeth 91 of the external teeth member 90 mesh with the external teeth 64 of the turning member 61. The external teeth member 90 transmits the rotation of the output shaft 56 to the turning member 61.

For example, the cup 80 is formed of a metal in the shape of a cylinder having a bottom. The cup 80 is inserted to a radial inner side of the cylinder section 62 by insert molding such that a bottom outer wall surface 811 of the cup 80 and an outer wall surface 621 of the cylinder section 62 on the front housing 22 side define the same flat surface. An end portion of the cup 80 on an opening side is in contact with a convex section 65 of the cylinder section 62 protruding radially inward. Convexes and concaves are formed on a radial outer wall of the cup 80. Therefore, axial movement of the cup 80 is restricted.

The ball bearing 82 is formed in the shape of a circular ring and has an outer race 83, an inner race 84, rolling elements 85 and the like. The ball bearing 82 is structured such that the rolling elements 85 enable relative rotation between the outer race 83 and the inner race 84. The outer race 83 is fitted to a radial inner wall of the cup 80. The inner race 84 is fitted to a radial outer wall of the shaft 86. Thus, the turning member 61 turns using the axis line of the shaft 86 as the central axis of the turning in accordance with the rotation angle of the output shaft 56.

For example, the plate 87 is formed of a metal in the shape of a round plate and has a round hole 88 in its central portion. An inner wall of the round hole 88 of the plate 87 is in contact with an outer wall of a convex section 28 protruding from the front housing 22 on a side opposite from the internal space 24. The convex section 28 restricts radial movement of the plate 87.

One side surface of the plate 87 slidably contacts an end surface 221 of the front housing 22 around the shaft 86. The other side surface of the plate 87 slidably contacts the bottom outer wall surface 811 of the cup 80 and the axial outer wall surface 621 of the turning member 61. Thus, axial movement of the cup 80 and the turning member 61 is restricted. Since the plate 87 slides on the front housing 22, the cup 80 and the turning member 61, the turning member 61 can turn smoothly.

A peripheral wall 29 is provided radially outside the turning member 61 such that the peripheral wall 29 surrounds the periphery of the turning member 61. The peripheral wall 29 is formed integrally with the front housing 22. The cover 72 is formed in the shape of a cylindrical bowl having a bottom. An outer wall of an end portion of the cover 72 on an opening side is fitted to an inside of the peripheral wall 29. Thus, the turning member 61 is accommodated in an accommodation space 40 formed between the cover 72 and the front housing 22. An O-ring 99 is inserted between the peripheral wall 29 and the cover 72. The O-ring 99 prevents water and the like from entering the accommodation space 40 from an exterior.

The turning angle sensor 70 is formed substantially in a cylindrical shape. One end portion of the turning angle sensor 70 is fixed to the cover 72 and the other end portion of the turning angle sensor 70 protrudes to the accommodation space 40 side. The other end portion of the turning angle sensor 70 is inserted into a radial inner side of the cylinder section 62. An axis fine of the turning angle sensor 70 coincides with an axis line of the shaft 86.

The turning angle sensor 70 has a magnetism detection element (for example, Hall IC) inside. The magnetism detection element is fixed to a position radially inside the cylinder section 62 of the turning member 61. A magnet section 77 is provided on an inner wall of the cylinder section 62 of the turning member 61. The magnet section 77 has magnets 75, 76 and a yoke 78. If the turning member 61 rotates and the magnet section 77 rotates, a magnetic flux density applied to the magnetism detection element changes. The turning angle sensor 70 senses the turning angle of the turning member 61 based on the magnetic flux density applied to the magnetism detection element.

The turning angle sensor 70 outputs a sensing signal to the ECU via a terminal 74 provided in a connector 73. The ECU senses the turning angle of the output shaft 56 from the turning angle of the turning member 61 using the sensing signal outputted by the turning angle sensor 70. Since the output shaft 56 is connected with the drive section 4 of the shift range switching device 1, the ECU can sense a set position of the shift range of the automatic transmission.

A torsion spring 95 is provided radially outside the turning member 61. One end of the torsion spring 95 is engaged with a convex section 96 provided to the front housing 22. The other end of the torsion spring 95 is engaged with a recess section 67 provided on the cylinder section 62 of the turning member 61. The torsion spring 95 biases the turning member 61 in a predetermined rotation direction to absorb rattling due to backlash between the external teeth 91 of the external teeth member 90 and the external teeth 64 of the turning member 61.

Next, an assembly procedure of the shift position sensor 60 according to the present embodiment will be explained.

As a first process, insert molding is performed such that the one end portion of the shaft 86 is inserted in the front housing 22. Thus, the shaft 86 is fixed to the front housing 22 such that the shaft 86 cannot perform the relative rotation with respect to the front housing 22.

As a second process, insert molding is performed such that the cup 80 is inserted radially inside the turning member 61. At that time, positioning is performed such that the bottom outer wall surface 811 of the cup 80 and the axial outer wall surface 621 of the turning member 61, which faces the front housing 22 side when the turning member 61 is attached to the shaft 86, define the same flat surface.

Next, as a third process, the ball bearing 82 is press-fitted to the radial inner side of the cup 80 and the outer race 83 of the ball bearing 82 and the radial inner wall of the cup 80 are fitted to each other.

As a subsequent fourth process, the plate 87 is inserted to the shaft 86, and then, the ball bearing 82 integrated with the turning member 61 and the cup 80 is press-fitted to the shaft 86. The external teeth 64 of the turning member 61 are meshed with a specified position of the external teeth member 90. At that time, the inner wall of the inner race 84 of the ball bearing 82 and the outer wall of the shaft 86 are fitted to each other. At the same time, both of the bottom outer wall surface 811 of the cup 80 and the axial outer wall surface 621 of the turning member 61 are brought into contact with the plate 87 to be able to turn relative to the plate 87. Thus, positioning between the turning member 61 and the shaft 86 is achieved. In addition, positioning of two points of the bottom outer wall surface 811 of the cup 80 and the axial outer wall surface 621 of the turning member 61, the two point being different from each other at least in the circumferential direction, is achieved. Thus, inclination of the turning central axis of the turning member 61 with respect to the axis of the shaft 86 can be inhibited.

Then, the torsion spring 95 is set radially outside the turning member 61, and the cover 72 having the turning angle sensor 70 is attached to the peripheral wall 29 of the front housing 22. Thus, the assembly of the shift position sensor 60 is completed.

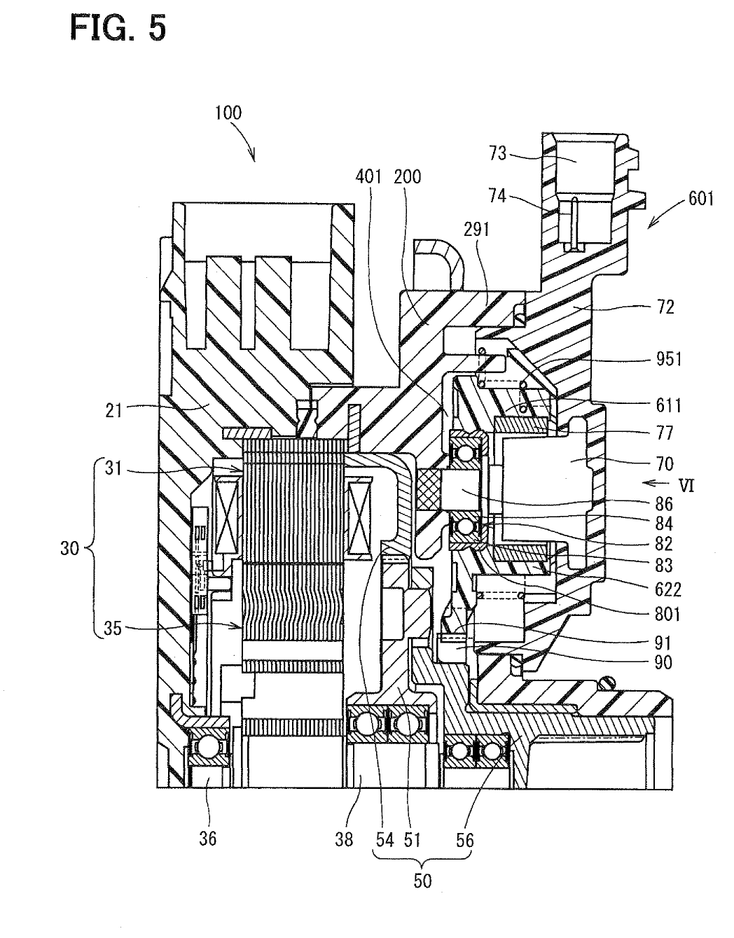

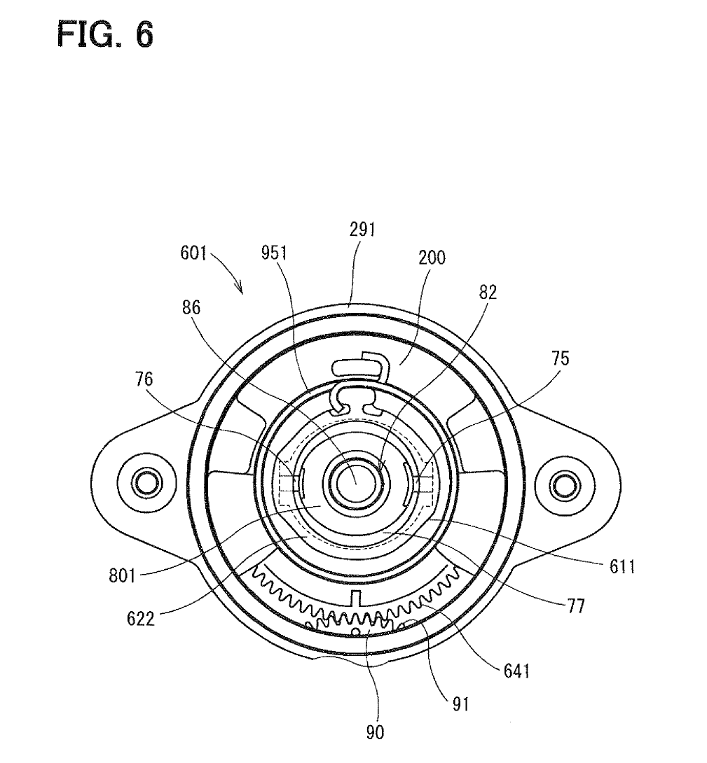

As a comparative example of the present invention, a rotary actuator 100 is shown in FIGS. 5 and 6.

In the comparative example, an opening side of a cup 801 faces a front housing 200. The front housing 200 forms a space 401 between the front housing 200 and both of the cup 801 and a turning member 611.

An assembly procedure of a shift position sensor 601 of the comparative example is as follows. First, insert formation is performed such that one end portion of the shaft 86 is inserted in the front housing 200, whereby the shaft 86 is fixed to the front housing 200 such that relative rotation therebetween is impossible.

Then, insert molding is performed such that the cup 801 is inserted radially inside a cylinder section 622 of the turning member 611. At that time, the cup 801 is inserted such that an opening thereof faces the front housing 200 side.

Then, the ball bearing 82 is press-fitted to the radial inside of the cup 801, and the outer wall of the outer race 83 of the ball bearing 82 and the inner wall of the cup 801 are fitted to each other. Subsequently, the ball bearing 82 is press-fitted to the other end portion of the shaft 86 protruding from the front housing 200, and the inner wall of the inner race 84 of the ball bearing 82 and the outer wall of the shaft 86 are fitted to each other. At that time, external teeth 641 of the turning member 611 are meshed with a specified position of the external teeth member 90. Thus, the turning member 611 is fixed to the shaft 86 by the ball bearing 82 and the cup 801 rotatably.

Then, a torsion spring 951 is set radially outside the turning member 611, and the cover 72 having the turning angle sensor 70 is attached to a peripheral wall 291 of the front housing 200. Thus, the assembly of the shift position sensor 601 is completed.

In the present embodiment, the bottom outer wall surface 811 of the cup 80 and the axial outer wall surface 621 of the turning member 61 slidably contact the plate 87 provided around the shaft 86 of the front housing 22. Therefore, the axial movement of the turning member 61 and the cup 80 is restricted. Thus, even when the inclination of the output shaft 56 connected to the drive shaft 4 of the shift range switching device 1 is transmitted to the turning member 61 via the external teeth member 90, the inclination of the turning central axis of the turning member 61 with respect to the axis line of the shaft 86 is inhibited. As a result, change of the magnetic field of the magnet section 77 due to the inclination of the turning central axis of the turning member 61 is inhibited, and the turning angle sensor 70 can correctly sense the change of the magnetic field of the magnet section 77 caused by the circumferential movement of the turning member 61.

The cup 80 opens on a side opposite from the front housing 22. Therefore, even after the ball bearing 82 is press-fitted to the shaft 86, the ball bearing 82 can be checked easily.

In the manufacturing process of the rotary actuator 10 of the present embodiment, when the ball bearing 82 is press-fitted to the shaft 86, a press-fitting force is adjusted. Thus, the bottom outer wall surface 811 of the cup 80 and the axial outer wall surface 621 of the turning member 61 are placed in contact with the plate 87 slidably. Thus, the inclination of the turning central axis of the turning member 61 with respect to the axis of the shaft 86 can be inhibited. Thus, the turning angle sensor 70 can correctly sense the change of the magnetic field of the magnet section 77 caused by the circumferential movement of the turning member 61. As a result, the turning angle of the output shaft 56 is sensed correctly, and the sensing accuracy of the shift position sensor 60 can be improved.

### Other Embodiments

In the above-described embodiment, the plate 87 is provided between the end surface 221 of the front housing 22 around the shaft 86 and both of the bottom outer wall surface 811 of the cup 80 and the axial outer wall surface 621 of the turning member 61. Alternatively, a restriction section that slides on the bottom outer wall surface of the cup and the axial outer wall surface of the turning member may be provided integrally with the front housing on a side facing the cup and the turning member.

As other embodiments of the present invention, the rotary actuator according to the present invention may be applied to various types of functional parts in place of the shift-by-wire system.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A rotary actuator comprising:
an electric motor;
a rotor shaft driven and rotated by the electric motor;
a speed reducer that reduces speed of rotation of the rotor shaft and outputs the rotation;
a housing that accommodates the electric motor and the speed reducer;
a shaft fixed to the housing;
a bearing that has an inner race fixed to the shaft and an outer race provided to be able to rotate relative to the inner race;
an external teeth member that is provided radially outside an output shaft of the speed reducer and that rotates together with the output shaft;
a turning member that has external teeth meshed with the external teeth member and that is supported such that the turning member can turn about an axis line of the shaft;
a magnet section that is provided to the turning member and that turns together with the turning member;
a turning angle sensing device that senses a turning angle of the turning member by sensing a magnetic field corresponding to a turning angle of the magnet section;
a cup that is formed in the shape of a cylinder having a bottom, wherein an outer wall of the cup is fixed to an inner wall of a shaft hole of the turning member and an inner wall of the cup is fitted to an outer wall of the outer race of the bearing; and
a restriction section that is provided around the shaft of the housing and that restricts inclination of a turning central axis of the turning member by slidably contacting a bottom outer wall surface of the cylindrical shape of the cup having the bottom.

2. The rotary actuator as in claim 1, wherein
the restriction section slidably contacts an axial outer wall surface of the turning member.

3. The rotary actuator as in claim 1, wherein
the restriction section is a plate that has one side surface slidably contacting an end surface of the housing around the shaft and that has the other side surface slidably contacting at least one of the bottom outer wall surface of the cup and an axial outer wall surface of the turning member.

4. A manufacturing method for manufacturing the rotary actuator as in claim 1, the manufacturing method comprising:
a first process of fixing the shaft to the housing;
a second process of fixing the cup to the shaft hole of the turning member;
a third process of fitting the outer wall of the outer race of the bearing to the radial inner wall of the cup; and
a fourth process of fitting an inner wall of the inner race of the bearing to the shaft fixed to the housing and of placing the bottom outer wall surface of the cylindrical shape of the cup having the bottom and the restriction section in contact with each other slidably.

5. The manufacturing method as in claim 4, wherein
the fourth process further places an axial outer wall surface of the turning member and the restriction section in contact with each other slidably when the bearing is press-fitted to the shaft.
